(19) United States
(12) Patent Application Publication
(10) Pub. No.: US 2014/0075111 A1
(43) Pub. Date: Mar. 13, 2014

(54) Block Level Management with Service Level Agreement

(71) Applicant: Robert Pike, Woodinville, WA (US)

(72) Inventor: Robert Pike, Woodinville, WA (US)

(73) Assignee: TRANSPARENT IO, INC., Woodinville, WA (US)

(21) Appl. No.: 13/612,943

(22) Filed: Sep. 13, 2012

(51) Int. Cl. G06F 3/06

(52) U.S. Cl. CPC G06F 3/061; G06F 3/0689; G06F 3/065
USPC 711/114

(57) ABSTRACT

A storage management system may create a logical storage unit from blocks of storage provided from multiple storage devices. The storage management system may operate using a service level agreement that defines a preferred or minimum performance standard for accesses to the logical storage unit. The service level agreement may include minimum replications, system performance, and system operation characteristics. As read and write operations are performed against the logical storage unit, the configuration of the logical storage unit may be changed to meet the service level agreement. The storage management system may assess and map the capabilities of all available storage devices for a system, then provision a logical storage unit that may initially meet the target service level agreement. When system performance does not meet the service level agreement, read operations may be striped, alternative storage devices may be used, or the location of replicated blocks may be changed.

### BACKGROUND

Storage systems are used to store data for computers. In many datacenter or server computer systems, storage systems may have duplicate copies of data using various schemes, such as various flavors of RAID and other techniques.

Storage systems may be classified as either file level storage systems or block level storage systems. File level storage systems may present a file system to an operating system, and the storage system may manage the blocks of data that make up the files. A block level storage system may have addressable blocks of data that may be written and read from a computer system, where the computer system may manage the data stored on the blocks.

Direct attached storage (DAS) may be storage devices that are directly attached to a server or other computer. The server or computer may access the direct attached storage system without traversing a network. In general, direct attached storage is not readily accessible to other computers on a network. Direct attached storage generally provides block level storage in conjunction with a file system provided by an operating system on the server computer.

Network attached storage (NAS) may be storage systems that provide a file system that may be accessed over a network. A network attached storage system may provide file system services to one or many computers. In some cases, a single file system may be shared by multiple computers. In some cases, a network attached storage system may provide both block storage and file storage.

A storage area network (SAN) may be a storage system that may provide just block level storage accessed over a network. A storage area network system may be accessed by many devices across a network.

### SUMMARY

A storage management system may create a logical storage unit from blocks of storage provided from multiple storage devices. The storage management system may operate using a service level agreement that defines a preferred or minimum performance standard for accesses to the logical storage unit. The service level agreement may include minimum replications, system performance, and system operation characteristics. As read and write operations are performed against the logical storage unit, the configuration of the logical storage unit may be changed to meet the service level agreement. The storage management system may assess and map the capabilities of all available storage devices for a system, then provision a logical storage unit that may initially meet the target service level agreement. When system performance does not meet the service level agreement, read operations may be striped, alternative storage devices may be used, or the location of replicated blocks may be changed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a computer with a storage management system.

FIG. 2 is a diagram illustration of an embodiment showing a device with a storage management system.

FIG. 3 is a flowchart illustration of an embodiment showing a method for provisioning storage devices for a logical unit.

FIG. 4 is a flowchart illustration of an embodiment showing a method for modifying a deployment to meet a service level agreement.

### DETAILED DESCRIPTION

A storage management system may present a single logical unit while providing the logical unit on a plurality of devices. The storage management system may maintain a service level agreement by configuring the devices in different manners and placing blocks of data on different devices.

The storage management system may manage storage devices that may include direct attached storage devices, such as hard disk drives connected through various interfaces, solid state disk drives, volatile memory storage, and other media including optical storage and other magnetic storage media. The storage devices may also include storage available over a network, including network attached storage, storage area networks, and other storage devices accessed over a network.

Each storage device may be characterized using parameters similar to or derivable from a service level agreement. The device characterizations may be used to select and deploy devices to create logical units, as well as to modify the devices supporting an existing logical unit after deployment.

The service level agreement may identify minimum performance characteristics or other parameters that may be used to configure and manage a logical unit. The service level agreement may include performance metrics, such as number of input/output operations per unit time, latency of operations, bandwidth or throughput of operations, and other performance metrics. In some cases, a service level agreement may include optimizing parameters, such as preferring devices having lower cost or lower power consumption than other devices.

The service level agreement may include replication criteria, which may define a minimum number of different devices to store a given block. The replication criteria may identify certain types of storage devices to include or exclude.

The storage management system may receive a desired size of a logical unit along with a desired service level agreement. The storage management system may identify a group of available devices that may meet the service level agreement and provision the logical unit using the available devices.

During operation of the logical unit, the storage management system may identify when the service level agreement may be exceeded. The storage management system may reconfigure the provisioned devices in many different manners, for example by converting from synchronous to asynchronous write operations or striping read operations. In some cases, the storage management system may add or remove devices from supporting the logical unit, as well as moving blocks from one device to another to increase performance or otherwise meet the storage level agreement.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

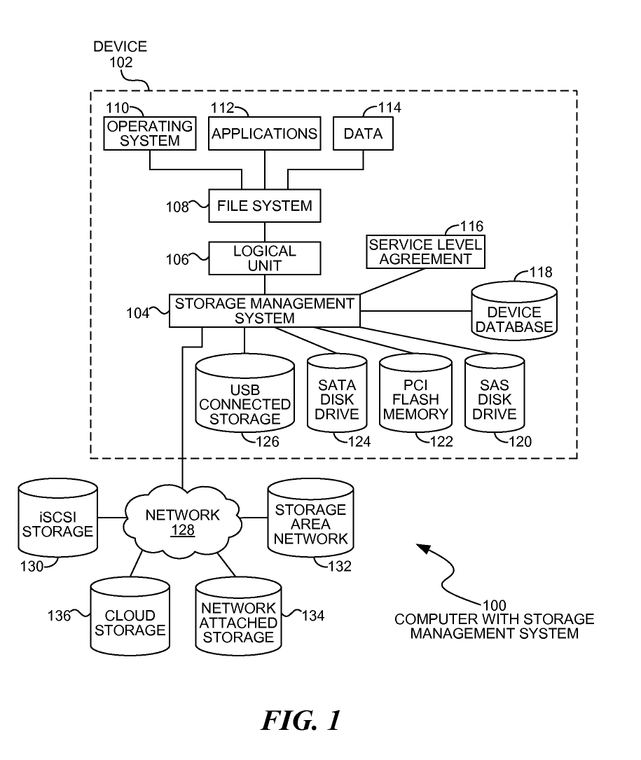

FIG. 1 is a diagram of an embodiment 100 showing a computer system 102 with a storage management system. Embodiment 100 illustrates a storage management system 104 that creates a logical unit 106 that a file system 108 may use to store and retrieve data.

The storage management system 104 may use multiple storage devices to create and manage the logical unit 106. The logical unit 106 may operate as a single storage device to the file system 108, and the file system 108 may interact with the logical unit 106 as if the logical unit 106 was a single disk drive or other storage mechanism.

The storage management system 104 may provide more capabilities than a single storage device. For example, the storage management system 104 may store each block of data on multiple storage devices. By storing each block of data on multiple devices, a failure of one of the storage devices may not compromise data integrity, since each block of data may have at least one backup copy on another device. Further, an error or fault on one device may be arbitrated or resolved by comparing the data from one or more other devices.

Striped read access may be possible when each block of data may be stored on multiple devices. Striped read access may allow multiple devices to read a different block simultaneously, allowing the logical unit to respond to read requests of multiple blocks with a throughput that may be higher than any single device. In such a configuration, the performance of a logical unit may be greater than a single storage device. In some embodiments, striped write access may be implemented.

Write operations may be configured to be symmetric or asymmetric. Symmetric write operations may simultaneously write to two or more devices, and may not complete until the last of the devices has successfully completed the write operation. Asymmetric write operations may complete a write request to a single device, then may later propagate the data change to another device. Symmetric write operations may ensure data integrity and have higher fault tolerance because multiple devices have a complete, up to data version of the data prior to finishing the write request. In contrast, asymmetric write operations may be higher speed, as the write operations may be completed when the fastest device has successfully completed the operation.

In some embodiments, write operations may be performed in a symmetric manner as a default. However, a service level agreement may permit changing to asymmetric write operations during periods of high write demands.

The storage management system 104 may manage the logical unit 106 by placing blocks of data on various storage devices. The blocks of data may be presented to the file system 108 as a single storage device. In many embodiments, the file system 108 may not be aware that the logical unit 106 may not be composed of multiple storage devices.

The file system 108 may manage files of data which may be accessed by an operating system 110 and various applications 112. The file system 108 may also store data 114 that may be accessed by the operating system 110 and applications 112.

A service level agreement 116 may define the performance metrics and other characteristics of the logical unit 106. The storage management system 104 may create the logical unit 106 according to the service level agreement 116, and then manage the logical unit 106 to meet the service level agreement 116 during operation.

Prior to creating the logical unit 106, the storage management system 104 may take an inventory of available storage devices and store descriptors of the storage devices in a device database 118. The inventory may include static descriptors of the various devices, including network address, physical location, available storage capacity, model number, interface type, and other descriptors.

The inventory may also include dynamic descriptors that define maximum and measured performance. The storage management system 104 may perform tests against a storage device to measure read and write performance, which may include latency, burst and saturated throughput, and other metrics. In some embodiments, the storage management system 104 may measure dynamic descriptors over time to determine when a service level agreement may not be met or to identify a change in a network or device configuration.

The storage management system 104 may manage many different types of devices to create and manage the logical unit 106. The devices may include SAS disk drives 120, PCI flash memory 122, SATA disk drives 124, USB connected storage 126. Such devices may represent typical storage devices that may be available on a conventional server or desktop computer.

Some embodiments may manage storage available over a network 128. In such embodiments, other storage devices attached to other server or desktop computers may be used, as well as iSCSI storage 130, storage area networks 132, network attached storage 134, and various forms of cloud storage 136.

Each of the various types of devices may have different performance or other characteristics. For example, locally attached devices may have faster response times than network attached devices. Some devices may have a higher capital cost or a higher operating cost. In many cases, higher performance devices may come with an increased capital cost or energy consumption.

Some devices may different reliability characteristics. Spinning media, notably hard disk drives, may fail in a catastrophic fashion, while solid state storage media may tend to fail gradually.

In each case, the storage devices may store various blocks of data, as opposed to storing individual files. In some instances, a single file may have part of the file stored in a first group of blocks on a first device, while another part of the file may be stored in a second group of blocks on a second device.

The block level management of a logical unit may enable the storage management system 104 to treat each block of data separately. For example, some blocks of a logical unit 106 may be accessed frequently while other blocks may not. The frequently accessed blocks may be placed on a storage device that offers increased performance, such as a local flash memory device, while other blocks may be placed on a device that offers poorer performance but may be operated at a lower cost.

The storage management system 104 may create and manage a logical unit 106 to meet criteria defined in a service level agreement 116. The service level agreement 116 may define a size for the logical unit 106, number of replications of blocks of data, and various performance characteristics of the logical unit 106.

The size of a logical unit 106 may be defined using thin or thick provisioning. In a thick provisioned logical unit, all of the storage requested for the logical unit may be provisioned and assigned to the logical unit. In a thin provisioned logical unit, the maximum size of the logical unit may be defined, but the physical storage may not be assigned to the logical unit until requested.

In a thin provisioned logical unit, the storage management system 104 may assign additional blocks of storage to the logical unit 106 over time. When the amount of storage actually being used grows to be close to the physical storage assigned, the storage management system 104 may identify additional storage for the logical unit. The additional storage may be selected to comply with the storage level agreement 116.

The number of replications of blocks of data may define how many different devices may store each block, as well as what type of devices. The replications may be used for fault tolerance as well as for performance characteristics.

Replications may be defined for fault tolerance by selecting a number of devices that store a block so that if one of the devices were to fail, the block may be retrieved from one of the remaining devices. In some embodiments, a replication policy may define that a local copy and a remote copy may be kept for each block. Such a policy may ensure that if the local device were compromised or failed, that the data may be recreated from the remote storage devices. In some policies, such remote devices may be defined to be another device within the same or different rack in a datacenter, for example. In some cases, a replication policy may define that an off premises storage device be included in the replication.

The replications may define whether a write operation may be performed in a synchronous or asynchronous manner. In an asynchronous write operation, the write operation may complete on one device, then the storage management system 104 may propagate the write operations to another device. When an off premises or other remote storage is used, some replication policies may permit the remote storage to be updated asynchronously, while writing synchronously to multiple local devices.

Replications may be defined for performance by selecting multiple devices that may support striping. Striping read operations may involve reading from multiple devices simultaneously, where each read operation may read a different block or different areas of a single block. As all of the data are read, the various portions of data may be concatenated and transmitted to the file system 108. Striping may increase read performance by a factor of the number of devices allocated to the striping operation.

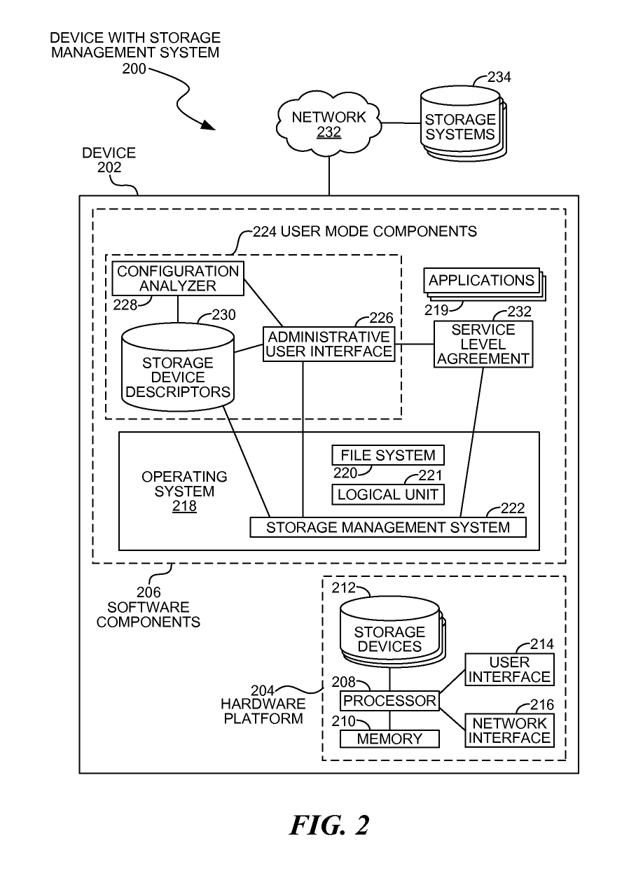

FIG. 2 is a diagram of an embodiment 200 showing a computer system with a storage management system. The storage management system may create and manage a logical unit for storage accessible by an operating system and applications, where the logical unit may be provided by multiple storage devices.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 may illustrate an example of a device that may have a managed logical unit. An operating system's file system may recognize the logical unit as a storage unit in the same way as a conventional disk drive may be treated as a storage unit. A storage management system may manage the logical unit by placing blocks of storage on multiple storage devices, which may provide a high degree of redundancy, fault tolerance, and increased performance over having the blocks of data stored on a single storage device.

The storage management system may use a service level agreement to define how the logical unit may be managed. The service level agreement may define various redundancy criteria, performance metrics, or other parameters for the logical unit. The storage management system may attempt to meet the service level agreement in the initial configuration of the logical unit, as well as make changes to the storage system to meet the service level agreement during operations.

Embodiment 200 illustrates a device 202 that may have a hardware platform 204 and various software components 206. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 that may have a file system 220 that interacts with a logical unit 221 provided by a storage management system 222. The operating system 218 may provide an abstraction layer between the hardware platform 204 and various software components, which may include applications, services, and various kernel and user level software components.

The file system 220 may create and manage files that may be accessed by the operating system 218 as well as various applications 219. The file system 220 may create files, apply permissions and various access controls to the files, and manage the files as distinct groups of storage.

The logical unit 221 may store the files in blocks of storage that may be allocated to the files. As files grow, additional blocks within the logical unit 221 may be assigned to the files.

The storage management system 222 may create and manage the storage according to a service level agreement 232.

The storage management system 222 may represent the kernel mode components that may make up a complete storage management system. An additional set of user mode components 224 may provide user access to managing the storage management system 222.

The user mode components 224 may include an administrative user interface 226, a configuration analyzer 228, and a set of storage device descriptors 230. The administrative user interface 226 may have a user interface through which a system administrator may configure and manage the storage management system. The user interface may allow the administrator to define a logical unit 221 and set the parameters by which the logical unit 221 may be operated. In some cases, the user interface may also allow the user to view the current and historical performance of the logical unit 221.

A configuration analyzer 228 may populate and update the storage device descriptors 230. The configuration analyzer 228 may discover all available storage devices and determine static and dynamic capacities of those devices. A static capacity may include currently available storage, physical location, network or local address, device type, and other parameters. Dynamic capacities may include various performance metrics that may be tested, measured, and monitored during operation. Such metrics may be burst and sustained bandwidth, latency, and other parameters.

The configuration analyzer 228 may monitor the storage devices over time. In some cases, the performance, capacity, or other parameters may change, which may trigger the storage management system 222 to make changes to the logical unit 221 in order to meet the service level agreement 232.

In some embodiments, the various storage management system components may communicate over a network 232 to access and manage various remote storage systems 234. The remote storage systems 234 may include storage area networks, network attached storage, cloud storage, and other storage devices that may be accessed over the network 232. In some cases, a service level agreement 232 may define that some or all of the blocks of data in the logical unit be stored on remote storage devices 234.

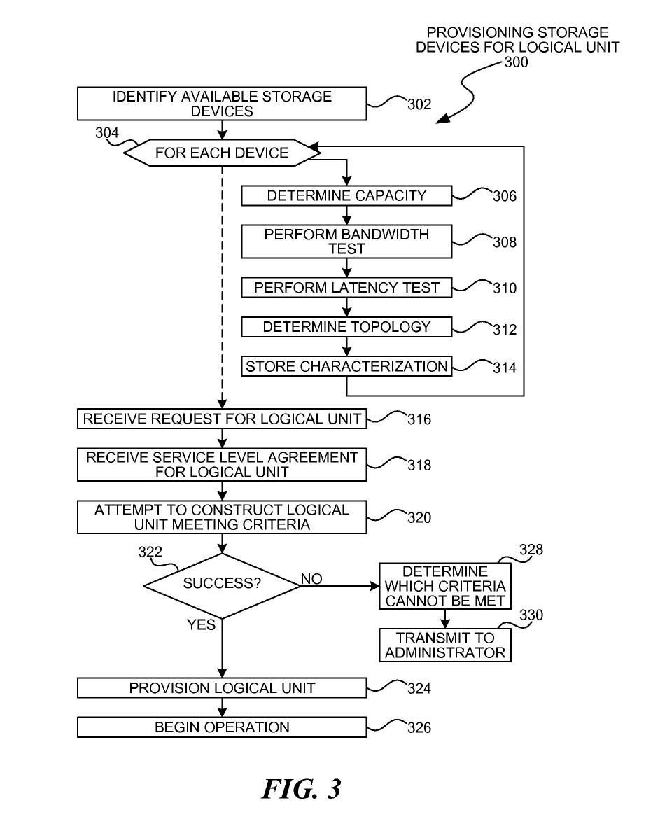

FIG. 3 is a flowchart illustration of an embodiment 300 showing a method for provisioning storage devices for a logical unit. Embodiment 300 illustrates one method by which a service level agreement may be used to configure and deploy a logical unit after gathering metadata about the available storage devices.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 302, all of the available storage devices may be identified. In some embodiments, a crawler or other automated component may detect and identify local and remotely attached storage devices. In some embodiments, a user may identify various storage devices to the system. Such embodiments may be useful when remotely available storage devices may not be readily accessible or identifiable to a crawler mechanism.

For each device in block 304, the capacity may be determined in block 306. The capacity may include the amount of raw storage that may be available on the device.

A bandwidth test may be performed in block 308 to determine the burst and sustained rate of data transfer to and from the device. Similarly, a latency test may be performed in block 310 to determine any initial or sustained latency in communication with the storage device. In some embodiments, the bandwidth and latency tests may be a dynamic performance test, where the communication to the device may be exercised. In some embodiments, the bandwidth and latency may be determined by determining the type of interface to the device and deriving expected performance parameters.

A dynamic performance test may be useful when a storage device may be accessed through a network or other connection. In such cases, the network connections may add performance barriers that may not be determinable through a static analysis of the connections.

The topology of the device may be determined in block 312. The topology may define the connections from a logic unit to the storage device. The topology may include whether or not the device may be local to the intended computing device. For remotely located devices, the topology may include whether the device is in the same or different rack, the same or different local area network, the same or different datacenter or other geographic location.

In many embodiments, a service level agreement may enforce a duplication parameter where duplicates of each block may be stored in various remote locations. For example, a service level agreement may define that a copy of all blocks be stored in a datacenter within a specific country but remote from the device accessing the logical unit.

After determining the topology and other metadata about the storage devices, the characterization of the storage devices may be stored in block 314.

A request for a logical unit may be received in block 316. The service level agreement may be received in block 318 for the logical unit.

In block 320, an attempt to construct a logical unit may be made according to the service level agreement. The logical unit may be constructed by first identifying storage devices that may meet the performance metrics defined in a service level agreement. In some cases, the performance metrics may be met by combining two or more storage devices together, such as striping devices to increase read performance.

Once the performance metrics may be met, the storage capacity of a logical unit may be attempted to be met by provisioning the storage devices. In some cases, the provisioning may be thin provisioning, where the full physical storage capacity may not be assigned or provisioned, and where the full physical storage capacity may or may not be available at the time the storage is provisioned.

If the storage management system has determined that a logical unit may be provisioned with success in block 322, the logical unit may be provisioned in block 324 and may begin operation in block 326.

If the storage management system determines that the service level agreement may not be met in block 322 to result in a successful provisioning, the criteria that may not be met may be determined in block 328. These criteria may be presented to an administrator in block 330, and the administrator may elect to change the criteria or make other changes to the system to meet the criteria. In some cases, the administrator may add more storage devices to the available storage devices to meet the deficiencies identified in block 328.

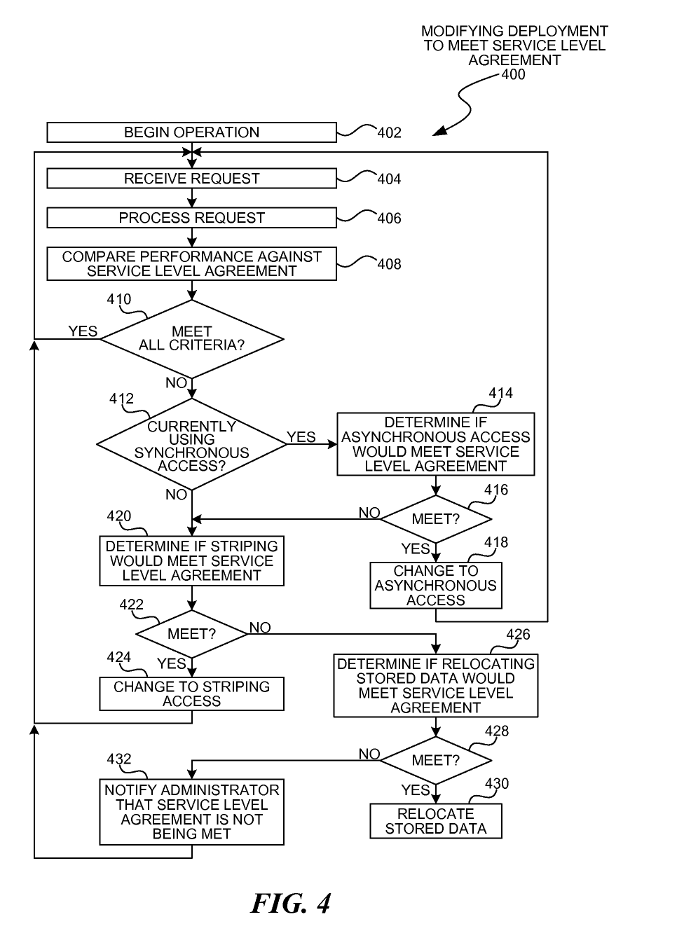

FIG. 4 is a flowchart illustration of an embodiment 400 showing a method for operating a logical unit, including changing the deployment to meet a service level agreement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 may illustrate some of the options that a storage management system may consider when encountering situations where a service level agreement may not be met.

The logical unit may begin operation in block 402.

A request for access to the logical unit may be received in block 404 and the request may be processed in block 406. The request may be a read request or write request.

The performance of the request may be compared to the service level agreement for the logical unit in block 408. When all the criteria for the service level agreement are met in block 410, the process may return to block 404 to process another request.

If the criteria of the service level agreement are not being met in block 410, the storage management system may attempt to meet the service level agreement by considering several different changes.

If the write access is currently a synchronous write access in block 412, a determination may be made in block 414 to determine if asynchronous access may meet the service level agreement in block 416. Synchronous write access may write the same block of data to multiple storage devices simultaneously and may be complete when the last device has finished writing. Asynchronous write access may be complete when the first of several devices has completed a write operation, leaving the system to propagate the write commands to other devices at a later time. Synchronous write access may be selected when an administrator wishes to prevent a confused state if a failure were to occur before all of the devices had completed writing.

In some embodiments, a service level agreement may prefer synchronous write operations, but may permit asynchronous write operations to meet a throughput or other performance issue. When asynchronous write operations are permitted by a service level agreement in block 414 and the asynchronous write operations would meet the service level agreement in block 416, write operations may be switched to asynchronous mode in block 418. The process may return to block 404 to service additional requests.

If the asynchronous operations would not be permitted or when the asynchronous operations would not meet the service level agreement in block 416, or when the access is currently asynchronous in block 412, a determination may be made in block 420 if striping would meet the service level agreement.

Striping is a mechanism by which read and write commands may be processed by multiple devices simultaneously. Each device may process a different block of a read or write command and therefore the throughput of the read or write operation may be increased proportionally.

If striping existing devices supporting the logical unit would meet the service level agreement in block 422, the access may be changed to striping access in block 424. The process may return to block 404 to service additional requests.

If striping cannot be accomplished using existing devices servicing a given logical unit in block 422, a determination may be made in block 426 if relocating blocks of data may meet the service level agreement. One of the scenarios that a storage management system may consider is locating certain blocks of data on faster storage devices or for configuring multiple devices for striping access. If such a change may meet the service level agreement in block 428, the stored data may be moved in block 430 and the process may return to block 404 to process additional requests. If such a change may not be possible and the service level agreement may not be met, an administrator may be notified in block 432. The process may return to block 404 to continue processing requests, but may not meet the service level agreement until the administrator reconfigures the storage devices or changes the service level agreement.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
identifying a plurality of storage devices accessible by said computer processor;
for each of said plurality of storage devices, characterizing a storage device;
receiving a service level agreement for a logical unit;
provisioning a first set of storage devices as said logical unit to meet said service level agreement, said first set of storage devices being a subset of said plurality of storage devices; and
operating said first set of said plurality of storage devices as said logical unit.

2. The method of claim 1, said service level agreement comprising a minimum performance level.

3. The method of claim 2, said minimum performance level defining a minimum number of input/output operations per unit time.

4. The method of claim 2, said minimum performance level defining a maximum latency for a read operation.

5. The method of claim 2, said service level agreement comprising a minimum replication level, said minimum replication level defining a number of different devices on which to store a block of data.

6. The method of claim 2, at least two of said first set of said plurality of storage devices having different performance characteristics.

7. The method of claim 1, said provisioning being a thin provisioning.

8. The method of claim 1, said provisioning being a thick provisioning.

9. The method of claim 1 further comprising:
determining that read operations to said logical unit exceed said service level agreement; and
striping a read request over a plurality of said first set of storage devices.

10. The method of claim 1 further comprising:
determining that read operations to a first block within said logical unit exceed said service level agreement; and
copying said first block from a first device to a second device, said second device having improved performance characteristics over said first device.

11. The method of claim 1 further comprising:
determining that write operations to a first block within said logical unit exceed said service level agreement;
determining that said service level agreement permits asynchronous write operations; and
changing from synchronous write operations to asynchronous write operations for said first block.

12. The method of claim 1 further comprising:
determining that write operations to a first block within said logical unit exceed said service level agreement;
determining that said service level agreement does not permit asynchronous write operations;
identifying a first device causing said write operations to exceed said service level agreement; and
moving said first block to a second device, said second device having performance characteristics such that said service level agreement is maintained.

13. The method of claim 12 further comprising:
adding said second device to said subset of devices after said identifying said first device is causing said write operations to exceed said service level agreement.

14. A system comprising:
a processor;
a plurality of storage devices;
a file system operating on said processor, said file system storing files on a logical unit;
a storage management system that:
identifies said plurality of storage devices;
for each of said plurality of storage devices, characterizes a storage device;
receives a service level agreement for a logical unit;
provisions a first set of storage devices as said logical unit to meet said service level agreement, said first set of storage devices being a subset of said plurality of storage devices; and
operates said first set of said plurality of storage devices as said logical unit.

15. The system of claim 14, said operating system operating within a virtual machine.

16. The system of claim 15, said logical unit being a virtual hard disk.

17. The system of claim 14, at least two of said storage devices having different performance characteristics.

18. The system of claim 17, one of said subset being a direct access storage device.

19. The system of claim 17, one of said subset being a storage area network storage device.

20. The system of claim 14, said storage management system that further:
determines that said subset of storage devices cannot meet said service level agreement for read operations; and
configuring said storage management system to stripe read operations across a plurality of said subset of storage devices.
